(19) United States
(12) Patent Application Publication
(10) Pub. No.: US 2026/0081749 A1
(43) Pub. Date: Mar. 19, 2026

(54) ROBUST FPGA BASED INTERFACE TO ALLOW SERIAL COMMUNICATIONS WITH EMBEDDED CLOCKING BETWEEN DEVICES WITH GROUND POTENTIAL DIFFERENCES

(71) Applicant: BAE Systems Information and Electronic Systems Integration Inc., Nashua, NH (US)

(72) Inventors: Matthew B. Brown, Milford, NH (US); Thomas E. Nielson, Westford, MA (US); Christopher E. Butrym, Hudson, NH (US); Werner E. Niebel, Hollis, NH (US)

(73) Assignee: BAE Systems Information and Electronic Systems Integration Inc., Nashua, NH (US)

(21) Appl. No.: 18/885,057

(22) Filed: Sep. 13, 2024

(51) Int. Cl. H04L 5/14; H04L 7/04

(52) U.S. Cl. CPC H04L 5/1461; H04L 7/042

(57) ABSTRACT

A bi-directional full-duplex interface or serial communication interface operable to connected to a first device and a second device to decode or encode a signal between the first device and the second device in the first line code or the second line code. The bi-directional full-duplex interface includes a receive path that converts a first data signal output from the first device at a first communication rate to a second line code for the second device where the first communicate rate is slower than the second line code. The bi-directional full-duplex interface also includes a transmit path that converts a second data signal output from the second device at the second communication rate to the first line code for the first device.

### TECHNICAL FIELD

The present disclosure generally relates to a serial communication interface, particularly a transformer coupled interface that is interoperable between modern and legacy devices in noisy environments with ground potential differences.

### BACKGROUND ART

Serial interface communications are commonly used in both the civilian and military industries for various devices, assemblies, and systems. Generally, in order for a serial interface communication to function each device, assembly, or system that is connect on a common serial interface, all devices, assemblies, or systems that are connected on the common serial interface must share a common communication protocol. With such common communication protocol, each device, assembly, or system may be in communication with one another to transmit or receive information along said common serial interface.

However, issues may arise when communication capabilities and/or interoperability are impinged due to uses of both modern and legacy equipment. In one example, a platform or vehicle may include multiple devices, assemblies, or systems that communicate with one another on a common serial interface. In this example, however, replacing one or more of these devices, assemblies, or systems and replacing such device, assembly, or system with an identical or matching device, assembly, or system may be extremely difficult due to various reasons. In one specific instance, a communication issue may arise when replacing one or more of these devices, assemblies, or systems is improbable due to such devices, assemblies, or systems being obsolete and unavailable. With such issues, the remaining devices, assemblies, or systems that are functional, yet obsolete and outdated, will need to be replaced in order for the platform and/or vehicle to function properly with respect to the common serial interface communication. Such issues may incur additional labor, increase in costs to replace an entire serial interface communication system, and replacement of other peripheral devices or components that rely upon such communication.

### SUMMARY OF THE INVENTION

In one aspect, an exemplary embodiment of the present disclosure may provide a system. The system includes a first device that is operable to communicate at a first line code, wherein the first device is a legacy hardware unit. The system also includes a second device that is operable to communicate at a second line code that is different than the first line code. The system also includes a bi-directional full-duplex interface that is connected to the first device and to the second device for communicating between the first device and the second device; wherein the bi-directional full-duplex interface is transformer coupled and operable to decode or encode a signal between the first device and the second device in the first line code or the second line code.

This exemplary embodiment or another exemplary embodiment may further include that when the bi-directional full-duplex interface receives a first data signal at the first line code from the first device, the bi-directional full-duplex interface is operable to convert the first data signal to the second line code for the second device; and wherein when the bi-directional full-duplex interface receives a second data signal at the second line code from the second device, the bi-directional full-duplex interface is operable to convert the second data signal to the first line code for the first device. This exemplary embodiment or another exemplary embodiment may further include that the bi-directional full-duplex interface comprises: a first circuitry component connected with a first input of the first device and a first output of the first device; and a second circuitry component operable with the first circuitry device and connected with a second input of the second device and a second output of the second device. This exemplary embodiment or another exemplary embodiment may further include that the bi-directional full-duplex interface further comprises: a receive path that connects the first output of the first device with the second input of the second device, wherein a first data signal is communicated along the receive path; and a transmit path that connects the second output of the second device with the first input of the first device, wherein a second data signal is communicated along the transmit path. This exemplary embodiment or another exemplary embodiment may further include that the receive path of the first circuitry component comprises: a receive transformer connected to the first output of the first device; and an equalizer connected and in series with the transformer. This exemplary embodiment or another exemplary embodiment may further include that the receive path of the second circuitry component comprises: a clock data recovery unit connected and in series with the equalizer; a reference clock operable with the clock data recovery unit; a receive framing logic component connected and in series with the clock data recovery unit; and a decoder connected to second input of the second device and in series with the receive framing logic component. This exemplary embodiment or another exemplary embodiment may further include that the clock data recovery unit of the second circuitry component comprises: a transceiver that is operable with the reference clock; and a clock-data recovery block (CDR) connected and in series with the transceiver. This exemplary embodiment or another exemplary embodiment may further include that the transmit path of the second circuitry component comprises: a transmit framing logic component connected to the second output of the second device; an encoder connected and in series with the transmit framing logic component; a serializer connected and in series with the encoder; and a buffer connected and in series with the serializer. This exemplary embodiment or another exemplary embodiment may further include that the transmit path of the first circuitry component comprises: a redriver connected and in series with the buffer; and a transmit transformer connected to the first output of the first device and is in series with the redriver. This exemplary embodiment or another exemplary embodiment may further include that the transmit path operates at or below 250 megabits per second speed. This exemplary embodiment or another exemplary embodiment may further include that the bi-directional full-duplex interface is equipped to the second device and separate from the first device. This exemplary embodiment or another exemplary embodiment may further include that the first line code and the second line code are in different formats.

In another aspect, an exemplary embodiment of the present disclosure may provide a bi-directional full-duplex interface that is connected to a first device and to a second device for communicating between the first device and the second device. The bi-directional full-duplex interface includes a first circuitry component that is connected with a first input of the first device and a first output of the first device. The bi-directional full-duplex interface also includes a second circuitry component that is operable with the first circuitry device and connected with a second input of the second device and a second output of the second device; wherein the bi-directional full-duplex interface is operable to decode or encode a signal between the first device and the second device in the first line code or the second line code.

This exemplary embodiment or another exemplary embodiment may further include that when the bi-directional full-duplex interface receives a first data signal at a first line code from the first device, the bi-directional full-duplex interface is operable to convert the first data signal to a second line code for the second device; and wherein when the bi-directional full-duplex interface receives a second data signal at the second line code from the second device, the bi-directional full-duplex interface is operable to convert the second data signal to the first line code for the first device; wherein the first line code and the second line code are different from one another. This exemplary embodiment or another exemplary embodiment may further include that that the bi-directional full-duplex interface further comprises: a receive path that connects the first output of the first device with the second input of the second device, wherein a first data signal is communicated along the receive path; and a transmit path that connects the second output of the second device with the first input of the first device, wherein a second data signal is communicated along the transmit path. This exemplary embodiment or another exemplary embodiment may further include that the receive path of the first circuitry component comprises: a receive transformer connected to the first output of the first device; and an equalizer connected and in series with the receive transformer. This exemplary embodiment or another exemplary embodiment may further include that the receive path of the second circuitry component comprises: a clock data recovery unit connected and in series with the equalizer; a reference clock operable with the clock data recovery unit; a receive framing logic component connected and in series with the clock data recovery unit; and a decoder connected to the second input of the second device and in series with the receive framing logic component. This exemplary embodiment or another exemplary embodiment may further include that the clock data recovery unit of the second circuitry component comprises: a transceiver that is operable with the reference clock; and a clock-data recovery block (CDR) connected and in series with the transceiver. This exemplary embodiment or another exemplary embodiment may further include that the transmit path of the second circuitry component comprises: a transmit framing logic component connected to the second output of the second device; an encoder connected and in series with the transmit framing logic component; a serializer connected and in series with the encoder; and a buffer connected and in series with the serializer. This exemplary embodiment or another exemplary embodiment may further include that the transmit path of the first circuitry component comprises: a redriver connected and in series with the buffer; and a transmit transformer connected to the first output of the first device and is in series with the redriver.

In yet another aspect, an exemplary embodiment of the present disclosure may provide a method. The method includes steps of connecting a bi-directional full-duplex interface with a first input of a first device and a first output of the first device; connecting the bi-directional full-duplex interface with a second input of a second device and a second output of the second device; receiving a first data signal at a first line code from the first device; converting the first data signal to a second line code for the second device; receiving a second data signal at the second line code from the second device; and converting the second data signal to the first line code for the first device; wherein the second line code is greater than the first line code.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1A is a diagrammatic view of a platform equipped with a communication system having a serial communication interface in accordance with one aspect of the present disclosure.

FIG. 1B is another diagrammatic view of the platform equipped with another communication system having a serial communication interface in accordance with another aspect of the present disclosure.

FIG. 2A is a block diagram of a receive path of the serial communication interface in accordance with one aspect of the present disclosure.

FIG. 2B is a block diagram of a transmit path of the serial communication interface in accordance with another aspect of the present disclosure.

FIG. 3 is a flowchart of a method of using the receive path of the serial communication interface.

FIG. 4 is a flowchart of a method of using the transmit path of the serial communication interface.

FIG. 5 is a flowchart of a method of using the receive and transmit paths of the serial communication interface.

Similar numbers refer to similar parts throughout the drawings.

### DETAILED DESCRIPTION

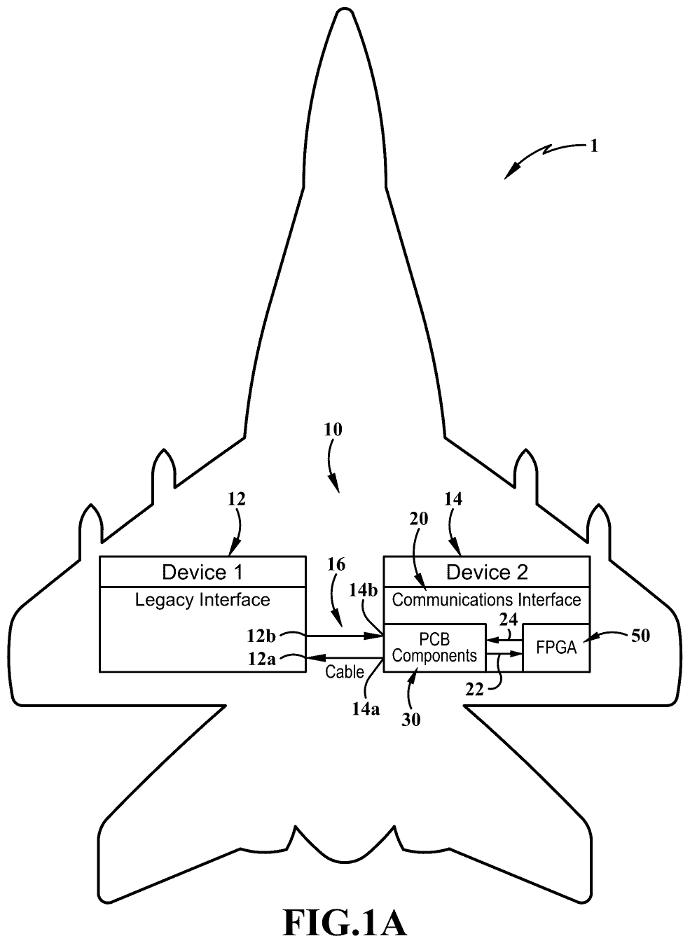

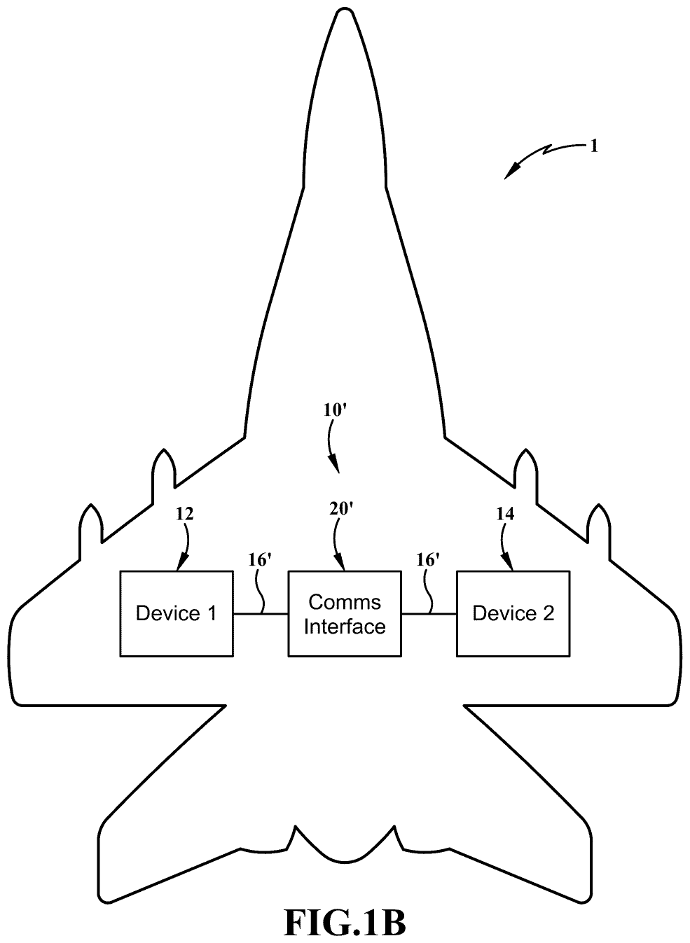

FIG. 1A illustrates a platform or vehicle 1 that is equipped with a communication system 10 (hereinafter “system”). In the present disclosure, system 10 includes at least first device 12 (labeled “Device 1” in FIG. 1A) that is operable to communicate at a first line code and includes a first input 12a and a first output 12b. System 10 also includes a second device 14 (labeled “Device 2” in FIG. 1A) that is operable to communicate at a second line code and includes a second input 14a and a second output 14b. System 10 also includes a cable or wiring harness 16 that connects the first device 12 and the second device 14 with one another, particularly at the first input 12a and the first output 12b of the first device 12 and the second input 14a and the second output 14b of the second device 14. It should be noted that the first device 12 is a legacy device with a legacy interface while the second device 14 is a modern device that includes a modern interface having commercially available components for communication operations discussed herein.

As discussed previously, system 10 includes first device 12 that is shown as a legacy and/or obsolete device, and second device 14 is shown as a modern and/or available device. In the present disclosure, first device 12 is operable to execute and use a standard or conventional 8-bit/10-bit tables for communication purposes. In one example, first device 12 may be operable to execute and use legacy non-standard 8-bit/10-bit encode/decode tables. With such operability, second device 14 is operable to execute and use 8-bit/10-bit tables to communicate with legacy first device 12 based on blocks or components included in a communication interface of second device 14, which are discussed in greater detail below. In a transmit path, first device 12 outputs a serial 10-bit data message (i.e., first line code) to second device 14 in which second device 14 is operable to translate such serial 10-bit data message to parallel 8-bit data (i.e., second line code); such translation and/or decode operations performed by second device 14 are discussed in greater detail below. In a receive path, second device 14 outputs a 8-bit data message (i.e., second line code) and converts said 8-bit data message to a serial 10-bit message (i.e., first line code) prior to being received by first device 12 in; such conversion and/or encode operations performed by second device 14 are discussed in greater detail below.

System 10 also includes a bi-directional full-duplex interface or serial communication interface 20 (hereinafter “communication interface”) that is equipped to second device 14. As discussed in greater detail below, the communication interface 20 is operable to convert messages or signals sent between the first device 12 and the second device 14 without reconfiguring and/or altering the logical communication of the first and second devices 14.

In the present disclosure, system 10 is shown equipped to platform 1 where platform 1 is a fixed-wing aircraft. It should be appreciated that system 10 is adapted to operably engage with any type of vehicle or platform, either military platform or civilian platform (regardless of whether it is manned or unmanned), as dictated by the implementation of system 10. In one example, system 10 described and illustrated herein platform 1 may be adapted to operably engage with an aerial military platform or vehicle. In another example, system 10 described and illustrated herein may be adapted to operably engage with a platform that is capable of moving in air, on land or at sea. In another example, system 10 described and illustrated herein may be adapted to operably engage with a platform that remains stationary. In yet another example, system 10 described and illustrated herein may be adapted to operably engage with a ground military platform. In yet another example, system 10 described and illustrated herein may be adapted to operably engage with a naval military platform (e.g., surface and sub-surface vessels). In yet another example, system 10 described and illustrated herein may be adapted to operably engage with a space-based platform. In yet another example, system 10 described and illustrated herein may also be used in a commercial and/or civilian application.

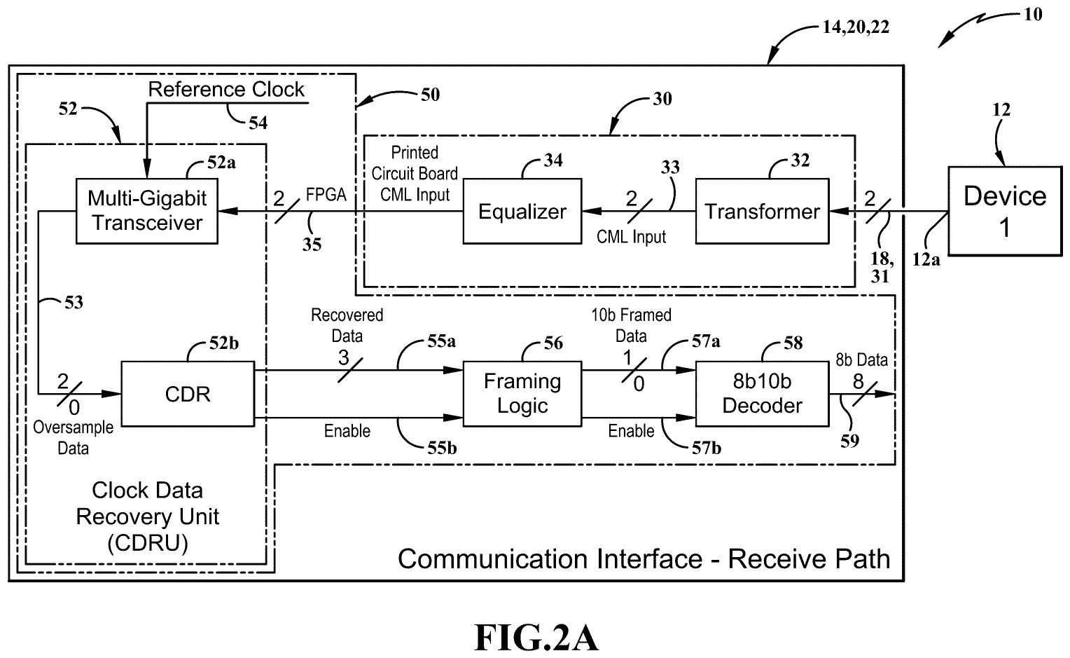

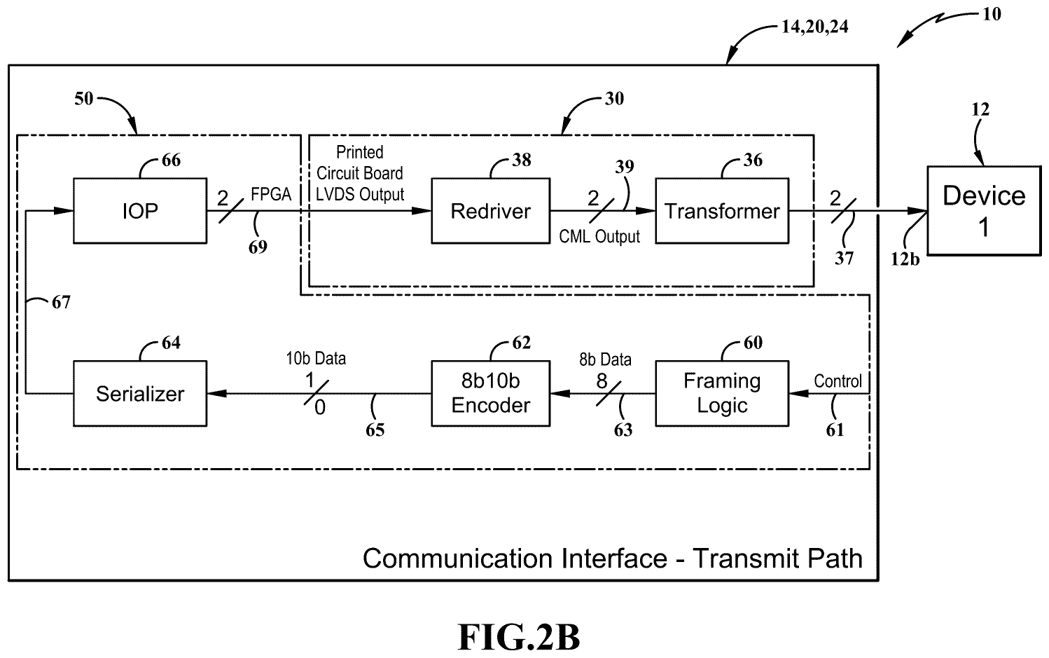

It should be understood that while communication interface 20 is equipped to second device 14, communication interface 20 of system 10 may be operable in other suitable configurations so that first device 12 and second device 14 may communicate with one another. In one exemplary embodiment, and as best seen in FIG. 1B, an alternative communication interface 20′ of an alternative system 10′ is a standalone device that is separate from the second device 14. In this exemplary embodiment, an alternative cable 16′ may be operable with communication interface 20′ so that communication interface 20′ is operable with both the first device 12 and the second device 14. In this exemplary embodiment, communication interface 20′ includes the same blocks and/or components that are included in communication interface 20 shown in FIGS. 1 and 2A-2B.

Referring now to the communication interface 20, communication interface 20 includes two primary communication paths or blocks, a first or receive path 22 and a second or transmit path 24. As best seen in FIG. 2A, the receive path 22 of the communication interface 20 is shown in a first communication arrangement where the receive path 22 connects with the first output 12b of the first device 12 and the second input 14a of the second device 14. In this arrangement, first device 12 outputs a message or signal at the first line code to the second device 14; such components that form the receive path 22 of the communication interface 20 to convert the first signal from the first line code to the second line code are discussed in greater detail below. As best seen in FIG. 2B, the transmit path 24 of the communication interface 20 is shown in a second communication arrangement where the transmit path 22 connects with the first input 12a of the first device 12 and the second output 14b of the second device 14. In this arrangement, second device 14 outputs a second message or signal at the second line code to the first device 12; such components that form the transmit path 24 of the communication interface 20 to convert the second signal from the second line code to the first line code are discussed in greater detail below are discussed in greater detail below.

Referring to FIGS. 2A-2B, communication interface 20 includes a first circuitry component or printed circuit board 30 that is connected with the first device 12. It should be noted that in this example all components positioned inside of a dash-dot-dot box in FIG. 2A are included with the first circuitry component 30 in the receive path 22. Similarly, it should also be noted that in this example all components positioned inside of a dash-dot-dot box in FIG. 2B are also included with the first circuitry component 30 in the transmit path 24. Such components that form the first circuitry component 30 are discussed in greater detail below.

Referring to FIG. 2A, the first circuitry component 30 includes a first or receive transformer 32 in the receive path 22 that is operatively connected to the first output 12b of the first device 12. In this present disclosure, two differential wires or electrical connections are used to connect the first device 12 and the first transformer 32 with one another; such electrical connection is denoted by an arrow labeled 31 in FIG. 2A. In operation, the first transformer 32 is operable to provide ground isolation for signals outputted from the first device 12 to the communication interface 20. In one example the first transformer 32 is an isolation transformer.

Still referring to FIG. 2A, first circuitry component 30 also includes an equalizer 34 in the receive path 22. In the present disclosure, the equalizer 34 is operatively connected to an output of the first transformer 32 such that the equalizer 34 is in series with the first transformer 32. In this present disclosure, two differential wires or electrical connections are also used to connect the first transformer 32 and the equalizer 34 with one another; such electrical connection is denoted by an arrow labeled 33 in FIG. 2A. In operation, equalizer 34 is operable to improve signal integrity and/or recover the incoming signal sent from the first device 12 and the first transformer 32. It should be noted that such signal sent from the first transformer 32 to the equalizer 34 is a current-mode logic (CML) input or signal. As discussed in greater detail below, two differential wires or electrical connections are used to connect the equalizer 34 with a clock data recovery unit of a second control circuitry of the communication interface 20; such electrical connection is denoted by an arrow labeled 35 in FIG. 2A.

Referring to FIG. 2B, first circuitry component 30 also includes a second transformer 36 in the transmit path 24 and is operatively connected to the first input 12a of the first device 12. In this present disclosure, two differential wires or electrical connections are used to connect the first device 12 and the second transformer 36 with one another; such electrical connection is denoted by an arrow labeled 37 in FIG. 2B. In operation, the second transformer 36 is also operable to provide ground isolation for signals outputted from communication interface 20 to the first device 12.

Still referring to FIG. 2B, first circuitry component 30 also includes a redriver 38 in the transmit path 24. In the present disclosure, the redriver 38 is operatively connected to an input of the second transformer 36 such that the redriver 38 is in series with the second transformer 36. In this present disclosure, two differential wires or electrical connections are also used to connect the second transformer 36 and the redriver 38 with one another; such electrical connection is denoted by an arrow labeled 39 in FIG. 2A. In operation, redriver 38 is operable to convert a second signal or field-programmable gate array (FPGA) output transmitted by the second device 14 to a CML output (at the first communication rate) prior to such message being received by the first device 12. As discussed in greater detail below, two differential wires or electrical connections are used to connect the redriver 38 with an input/output pin of a second control circuitry of the communication interface 20.

Referring to FIGS. 2A-2B, communication interface 20 also includes a second circuitry component 50, which may be an FPGA, that is directly connected with the second device 14. It should be noted that all components positioned inside of a dash-dot box in FIG. 2A are included with the second circuitry component 50 in the receive path 22. Similarly, it should be noted that all components positioned inside of a dash-dot box in FIG. 2B are included with the second circuitry component 50 in the transmit path 24. Such components that form the second circuitry component 50 are discussed in greater detail below.

Referring to FIG. 2A, second circuitry component 50 includes a clock data recovery unit 52 in the receive path 22. In the present disclosure, clock data recovery unit 52 is connected and in series with the equalizer 34 of the first circuitry component 30 via electrical connection 35. In operation, the clock data recovery unit 52 is operable to use serialized data to find and/or discover a clock that is embedded in the signal output from the first circuitry component 30 and the first device 12. Upon such operations performed by the clock data recovery unit 52, the clock data recovery unit 52 then splits and outputs such data into parallelized data. Such devices that are included in the clock data recovery unit 52 are discussed in greater detail below.

In the present disclosure, clock data recovery unit 52 includes a transceiver 52a that is connected and in series with the equalizer 34 of the first circuitry component 30 via electrical connection 35. In the second circuitry component 50, transceiver 52a is operable to be utilized in a receiving state in communication interface 20 when receiving the first signal from the first circuitry component 30, particularly the equalizer 34. In one example, transceiver 52a is a multi-gigabit transceiver that operates at 5 gigahertz for oversampling at a predetermined value; in this example, the oversampling rate is between a value of eight up to a value of twenty. As best seen in FIG. 2A and discussed herein, transceiver 52a is operable to output a twenty bit signal based on the oversampling of the transceiver 52a set to the value of twenty (labeled in FIG. 2A). It should also be noted that transceiver 52a is operable with a reference clock 54 in order to perform such oversampling operations.

Still referring to FIG. 2A, the clock data recovery unit 52 also includes a clock data recovery block (hereinafter CDR) 52b. In the present disclosure, CDR 52b is connected and in series with an output of the transceiver 52a; such connection between transceiver 52a and CDR 52b is denoted by an arrow labeled 53 in FIG. 2A. In operation, CDR 52b is operably to receive the oversampling data from the transceiver 52a and is configured to apply a clock/data recovery algorithm to the oversampled receive data for recovering the clock and to align said clock with the oversampled receive data. In general, CDR 52b is operable to count or capture edges of a fixed pattern of oversampled received data to find an appropriate clock frequency. Once captured, CDR 52b is then operable to align the captured bits until CDR 52b finds the expected sync word needed for a desired implementation. In one example, CDR 52b is operable to find and/or uncover a center or an eye of the oversampled data in order to extract data needed for framing logic and to feed the 8b/10b system upon receiving the oversampled data, which is discussed in greater detail below. It should be noted that such data extracted by CDR 52b may include a plurality of framing characters due to the embedded clock included in the signal output from the first device 12. Such data extracted by CDR 52b may also provide edges of data that is also needed for framing logic and to feed the 8b/10b system, which is discussed in greater detail below.

Still referring to CDR 52b, CDR 52b is operable to output an oversampled data signal or recovered data signal along an electrical connection to downstream components at a predetermined bit value at a desired rate; such electrical connection that transmits the recovered data signal from CDR 52b to downstream components is denoted by an arrow labeled 55a in FIG. 2A. In the present example, CDR 52b is operable to output three bits of data in each recovered data signal. It should be noted that such recovered data signal is also raw data that is output from the CDR 52b. Additionally, an enable signal is also outputted from CDR 52b to downstream components via another electrical connection; such electrical connection that transmits the enable signal from CDR 52b to downstream components is denoted by an arrow labeled 55b in FIG. 2A. In the present disclosure, the enable signal output by CDR 52b is used as a validation or check identifier due to each downstream component operating at different clocking parameters and/or settings. As such, the enable signal assists the downstream components to access the data output from clock data recovery unit 52.

Still referring to second circuitry component 50, second circuitry component 50 also includes a receive or first framing logic component 56 in the receive path 22. In the present disclosure, the first framing logic component 56 is connected and in series with the clock data recovery unit 52. More particularly, the first framing logic component 56 is connected and in series with an output of the CDR 52b of clock data recovery unit 52 via electrical connections 55a, 55b. In operation, first framing logic component 56 is operable to receive the recovered data signal from the CDR 52b at a first input, via electrical connection 55a, and receive the enabled signal at a second input, via electrical connection 55b.

Upon reception of these signals, first framing logic component 56 is operable to find and/or uncover desired framing characters based on the plurality of framing characters encoded in the oversampling data and recovered data outputted from clock data recovery unit 52. Upon discovering the framing characters, the first framing logic component 56 is then operable to align and arrange the framing characters. In one example the framing characters are arranged into a 10-bit logic or 10-bit framed data. The first framing logic component 56 is also operable to output the 10-bit framed data along an electrical connection to downstream components of the second circuitry component 50; such electrical connection that transmits the 10-bit framed data from first framing logic component 56 to downstream components is denoted by an arrow labeled 57a in FIG. 2A. Additionally, an enable signal is also outputted from first framing logic component 56 to downstream components of the second circuitry component 50 via another electrical connection; such electrical connection that transmits the enable signal from first framing logic component 56 to downstream components is denoted by an arrow labeled 57b in FIG. 2A. Similar to the enable signal outputted by CDR 52b, the enable signal outputted by first framing logic component 56 is also used as a validation or check identifier due to each downstream component operating at different clocking parameters and/or settings. As such, the enable signal assists the downstream components to access the data output from first framing logic component 56.

Still referring to second circuitry component 50, second circuitry component 50 also includes an 8-bit/10-bit decoding component or 8b10b decoder 58 in the receive path 22; for brevity, 8-bit/10-bit decoding component 58 will simply be referred to as decoder 58 hereinafter. In the present disclosure, the decoder 58 is connected and in series with an output of the first framing logic component via electrical connections 57a, 57b. In operation, decoder 58 is operable to receive the 10-bit framed data from the first framing logic component 56 at a first input, via electrical connection 57a, and receive the enabled signal at a second input, via electrical connection 57b.

Upon reception of these signals, decoder 58 is operable to convert and/or decode the 10-bit framed data from 10-bit logic to 8-bit logic for outputting 8-bit data to downstream devices in system 10, specifically second device 14. Such operability of the decoder 58 is programmed in this manner due to the configuration of the second device 14 in system 10. The decoder 58 is also operable to output the 8-bit data along an electrical connection to the second device 14; such electrical connection that transmits the 8-bit data from decoder 58 to the second device 14 is denoted by an arrow labeled 59 in FIG. 2A.

While 8b/10b is discussed herein and is used by system 10, other exemplary data signals may be used in the system 10 for conversion purposes outside of the 8-bit and 10-bit logic discuss herein. As such, communication interface 20 discussed herein may be used to transmit various types of known and/or industry standard logic signals or data signals that are currently available at the filing of this disclosure and that are not currently available at the filing of this disclosure.

Still referring to second circuitry component 50, second circuitry component 50 also includes a transmit or second framing logic component 60 in the transmit path 24. As best seen in FIG. 2B, the second framing logic component 60 is connected and in series with the second device 14 by an electrical connection 61 connecting the second output 14b of the second device 14 and an input of the second framing logic component 60; such electrical connection is denoted by an arrow labeled 61 in FIG. 2B.

In operation, the second framing logic component 60 receives a control or second signal from the second device 14, via electrical connection 61, that is meant to be sent downstream to first device 12. It should be noted that control or second message may include real data that includes no specific characters that relate to 8-bit logic while running at a clocking rate or speed. In one example, the control signal runs at a clocking rate of about 25 megabit per second. Second framing logic component 60 is operable to separate the data output by the second device 14 into framing characters and data. Upon being commanded to separate the framing characters, the second framing logic component 60 is then operable to align and arrange the framing characters into an 8-bit logic or 8-bit framed data. Such 8-bit data arranged by the second framing logic component 60 is then outputted 8-bit logic to downstream components of the second circuitry component 50 in which the 8-bit logic is separated from the control signal; such 8-bit logic data is denoted by an arrow labeled 63 in FIG. 2B.

Still referring to second circuitry component 50, second circuitry component 50 also includes an 8-bit/10-bit encoding component or 8b10b encoder 62 in the transmit path 24; for brevity, 8-bit/10-bit encoding component 62 will simply be referred to as encoder 62 hereinafter. As best seen in FIG. 2B, the encoder 62 is connected and in series with an output of the second framing logic component via electrical connection 63. In operation, encoder 62 is operable to receive the 8-bit data from the second framing logic component 60 at an input via electrical connection 63.

Upon reception of the 8-bit data, encoder 62 is operable to convert and/or encode the 8-bit data from 8-bit logic to 10-bit logic for outputting 10-bit data to downstream devices in system 10. Such encoding operations performed by encoder 62 is accomplished by encoder 62 executing 8b/10b logic tables to build and/or form a 10-bit symbol; such 8b/10b logic tables are installed with encoder 62. It should be noted that encoder 62 is operable to execute a preexisting and/or known 8b/10b logic tables that are used in 8b/10b conversion operations. Such operability of the encoder 62 is programmed in this manner due to the configuration of the first and second devices 12,14 in system 10. Upon such building of the 10-bit symbol, the encoder 62 then parallelizes the 10-bit data for serialization by downstream components of the second circuitry component 50, which is discussed in greater detail below. The encoder 62 is also operable to output the parallelized 10-bit symbols along an electrical connection to downstream components of the second circuitry component 50; such electrical connection that transmits the parallelized 10-bit symbol from encoder 62 to downstream components of the second circuitry component 50 is denoted by an arrow labeled 65 in FIG. 2B.

Still referring to second circuitry component 50, second circuitry component 50 also includes a serializing component or serializer 64. As best seen in FIG. 2B, serializer 64 is connected and in series with an output of the encoder 62 via electrical connection 65. In operation, serializer 64 is operable to receive the parallelized 10-bit symbols from the encoder 62 at an input via electrical connection 65.

Upon reception of the parallelized 10-bit symbol, serializer 64 is operable to serialize the data into a serial data that operates and/or runs at an increased clocking rate or speed as compared to the clocking speed initially outputted by the second device 14 and other upstream components of second circuitry component 50. In one example, serializer 64 is operable to serialize the data into a serial data that operates and/or runs at approximately 25 megabits per second. Upon such serialization, the serializer 64 is also operable to output the serialized data along an electrical connection to downstream components of the second circuitry component 50; such electrical connection that transmits the serialized data from serializer 64 downstream components of the second circuitry component 50 is denoted by an arrow labeled 67 in FIG. 2B. In other exemplary embodiments, serializer 64 may serialize the data at any suitable speed or rate dictated by the clock speeds of the devices of system 10 (e.g., the first device 12 and the second device 14).

Still referring to second circuitry component 50, second circuitry component 50 also includes an input/output pin (hereinafter “IOP”) 66. As best seen in FIG. 2B, IOP 66 is connected and in series with an output of serializer 64 via electrical connection 67. In operation, IOP 66 is operable to receive the serialized data from the serializer 64 at an input via electrical connection 67.

Upon reception of the serialized data, IOP 66 is operable to convert the serialized data into low-voltage differential signal (or LVDS) or TIA/EIA-644 signal. Upon such conversion, the IOP 66 is also operable to output the LVDS along an electrical connection to downstream components of system 10, specifically the redriver 38 of first circuitry component 30; such electrical connection that transmits the LVDS from IOP 66 to downstream components of the second circuitry component 50 is denoted by an arrow labeled 69 in FIG. 2B.

Such configuration of the communication interface 20 is considered advantageous at least because the communication interface 20 enables at least two devices (e.g., first and second devices 12, 14) to communicate with one another while having operating speed differences. As such, the communication interface 20 enables legacy/obsolete device and new/available devices to communicate with one another even though such device operates at different line codes. It should be understood that second circuitry component 50 may also operate at any suitable logical protocol and/or procedures. In one exemplary embodiment, the second circuitry component 50 operates at a FPGA-based logic protocol to provide flexibility and modularity with legacy and existing interfaces. In this embodiment, any devices or components used in the first circuitry component 30 or second circuitry component 50 may also be updated as technology progresses and eliminate issues of such communication interface 20 becoming obsolete.

The configuration of communication interface 20 is also considered advantageous at least because the communication interface 20 provides a compact, bi-directional capability between two or more devices to create cohesive transportation and/or transmission of data. Based on the configuration of the communication interface 20, the receive path 22 provides a first routing in a first communication direction from the first device 12 to the second device 14 while the second path 24 provides a second, separating routing in a second communication direction from the second device 14 to the first device 12. The compact configuration of communication interface 20 is also advantageous because such communication interface 20 may reduce the total cable and/or routing needed in the platform 1 thus reducing the overall weight and/or load in the platform 1 in certain configurations, including configuration that have 8b wiring to serialized differential pairs wiring. Such reduction in weight is possible due to the communication interface 20 reducing the need for more conductors in a cable since this interface 20 is capable of running at higher speeds as compared to standardized low-level interfaces (such as EIA/TIA-485 interfaces).

The configuration of communication interface 20 is also considered advantageous at least because the communication interface 20 isolates communication signals between devices that are connected with the communication interface 20. In one example, the communication interface 20 isolates communication signals from ground which may eliminate grounding differences of devices connected with the communication interface 20. In this particular example, such grounding differences between devices is prevented due to transformer coupling the communication interface 20 which decuples the ground interference on printed circuit cards or boards, such a first circuitry component 30. In another example, the communication interface 20 also isolates communication signals from electrostatic discharge (ESD) that occurs on a platform or inadvertent lighting events that occur near the platform when operating.

The configuration of communication interface 20 is also considered advantageous at least because the communication interface 20 varies signals in either receive path 22 or the transmit path 24 based on the devices connected to the communication interface 20. In one example, communication interface 20 may vary the clocking rate or speed along the transmit path 24 from the second device 14 to the first device 12. In this example, the communication interface 20 may convert and reduce the clocking speed from a first clocking speed (e.g., 1 gigabyte per second) of second device 14 to a second clocking speed (e.g., 250 megabits per second) that second device 14 is able to communicate with first device 12. The communication interface 20 may further convert and reduce the clocking speed from the second clocking speed to a third clocking speed (20 megabits per second) that is less than the second clocking speed prior to being received by the first device 12. In this embodiment, the 10-bit line rate that is being used by second device 14 is about ten times greater than the 8-bit line being used by first device 12 due to first device 12 being a legacy and/or obsolete device as compared to second device 14. In other exemplary embodiments, second clocking speed may be greater than 250 megabits dictated by the implementation of communication interface 20, including the cabling and/or electrical connections needed for greater clocking speeds.

Having discussed the components that represent the receive path 22 and the transmit path 24 of the communication interface 20, methods of sending signals between the first device 12 and the second device along communication interface 20 are now discussed in greater detail below.

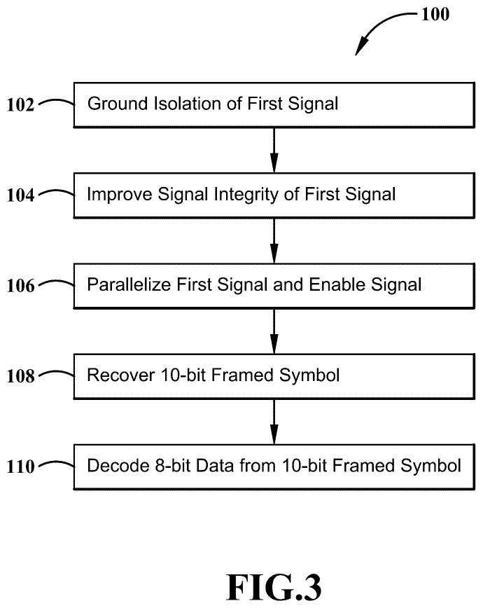

With respect to the receive path 22, a first or receive method 100 may be performed by communication interface 20 upon receiving a first signal from output 12b of first device 12 (see FIG. 3). Initially, the first transformer 32 of the first circuitry component 30 receives the first signal from the first device 12 along electrical connection 31. Upon receiving the first signal, the first transformer 32 is operable to provide ground isolation for messages and/or electrical signals outputted from the first device 12 to the communication interface 20; such operation is noted as step 102 of method 100. Once the first signal is output from first transformer 32, the equalizer 34 of the first circuitry component 30 then receives the first signal, via electrical connection 35. Upon receiving the first signal, the equalizer 34 is operable to improve signal integrity and/or recover the incoming signal sent from the first device 12 and the first transformer 32; such operation is noted as step 104 of method 100. As discussed above, the signal sent from the first transformer 32 to the equalizer 34 is a CML input signal.

Once CML input signal is output from the equalizer 34, the CML input signal is received by the second circuitry component 50, particularly the clock data recovery unit 52, via electrical connection 35. Upon receiving the CML input signal, clock data recovery unit 52 is operable find and/or discover a clock that is embedded in the signal or message output from the first circuitry component 30 and the first device 12. Upon such operations performed by the clock data recovery unit 52, the clock data recovery unit 52 then splits and outputs such data into parallelized data; such operation performed by clock data recovery unit 52 is noted as step 106 of method 100.

It should be understood, however, that transceiver 52a and CDR 52b of the clock data recovery unit 52 both perform operations in order to find and/or discover a clock that is embedded in the signal or message outputted from the first circuitry component 30 and the first device 12 which splits such discovered data into parallelized data noted in step 106. With respect to the transceiver 52a, transceiver 52a operates at 5 gigahertz for oversampling at a value of twenty. It should be noted that reference clock 54 is also fed into the transceiver when such oversampling is performed by transceiver 52a. With respect to the CDR 52b, CDR 52b is operable to find and/or uncover a center or an eye of the oversampled data in order to extract data needed for framing logic and to feed the 8b/10b system, which is discussed in greater detail below. It should be noted that such data extracted by CDR 52b may include a plurality of framing characters due to the embedded clock included in the signal output from the first device 12. Such data extracted by CDR 52b may also provide edges of data that is also needed for framing logic and to feed the 8b/10b system, which is discussed in greater detail below. Upon such processing by CDR 52b, CDR 52b is then operable to output the recovered data signal 55a to downstream components along with an enable signal 55b.

Once step 106 is performed, the parallelized data and enable signal is received by first framing logic component 56. At this stage of method 100, first framing logic component 56 is operable to find and/or uncover desired framing characters based on the plurality of framing characters encoded in the oversampling data and recovered data outputted from clock data recovery unit 52. Upon discovering the framing characters, the first framing logic component 56 is then operable to align and arrange the framing characters into a 10-bit logic or 10-bit framed data. The first framing logic component 56 is also operable to output the 10-bit framed data to downstream components of the second circuitry component 50 (denoted by arrow labeled 57a in FIG. 2A). Additionally, first framing logic component 56 also outputs enable signal along with the 10-bit frame data from first framing logic component 56 to downstream components of second circuitry component 50 (denoted by arrow labeled 57b in FIG. 2A). Such operation performed by first framing logic component 56 is noted as step 108 of method 100.

Once step 108 is performed, the 10-bit framed data and enable signal is then received by the decoder 58. At this stage in method 100, decoder 58 is operable to convert and/or decode the 10-bit framed data from 10-bit logic to 8-bit logic for outputting 8-bit data to downstream devices in system 10, specifically second device 14. Such operability of the decoder 58 is programmed in this manner due to the configuration of the second device 14 in system 10. The decoder 58 is also operable to output the 8-bit data to the second input 14a of the second device 14. Such operation performed by decoder 58 is noted as step 110 of method 100. Upon completion of step 110, the second device 14 receives the 8-bit data from decoder 58 to cease operation of method 100.

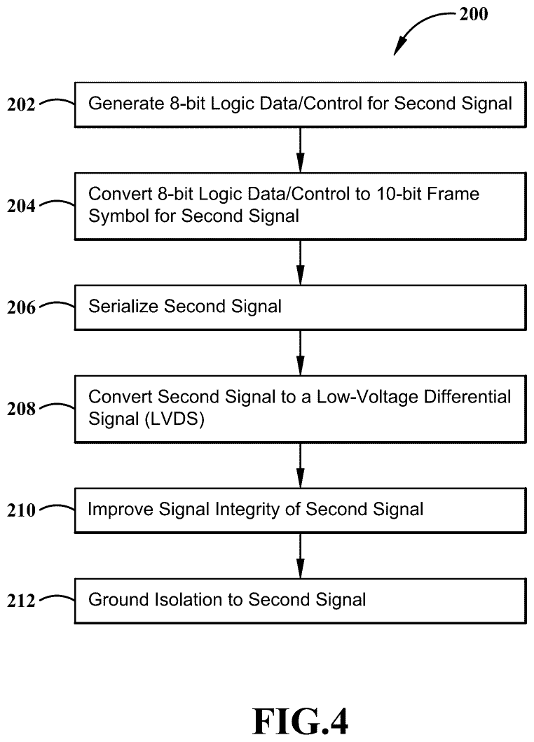

With respect to the transmit path 24, a second or transmit method 200 (see FIG. 4) may be performed by communication interface 20 upon receiving a control or second signal from second output 14b of second device 14. Initially, the second framing logic component 60 receives a control signal from the second device 14 that is meant to be sent downstream to first device 12. In operation, the second framing logic component 60 is operable to separate the data outputted by the second device 14 and an 8-bit data field into framing characters and data. Upon discovering the framing characters, the second framing logic component 60 is then operable to align and arrange the framing characters into an 8-bit logic or 8-bit framed data. Such 8-bit data arranged by the second framing logic component 60 is then output 8-bit logic to downstream components of the second circuitry component 50 in which the 8-bit logic that is separated from the control message. Such operation performed by second framing logic component 60 is noted as step 202 of method 200.

Once step 202 is performed, the 8-bit data is then received by the encoder 62. At this stage in method 200, encoder 62 is operable to convert and/or encode the 8-bit data from 8-bit logic to 10-bit logic for outputting 10-bit symbols to downstream devices in system 10. Such encoding operations performed by encoder 62 is accomplished by encoder 62 executing 8b/10b logic tables to build and/or form a 10-bit symbol. Such operability of the encoder 62 is programmed in this manner due to the configuration of the first and second devices 12,14 in system 10. Upon such building of the 10-bit symbol, the encoder 62 then parallelizes the 10-bit symbols for serialization by downstream components of the second circuitry component 50, which is discussed in greater detail below. The encoder 62 is also operable to output the parallelized 10-bit symbols along an electrical connection to downstream components of the second circuitry component 50. Such operation performed by encoder 62 is noted as step 204 of method 200.

Once step 204 is performed, the parallelized 8-bit/10-bit data is then received by the serializer 64. At this stage in method 200, serializer 64 is operable to serialize the data into a serial data that operates and/or runs at an increased clocking rate or speed as compared to the clocking speed initially outputted by the second device 14 and other upstream components of second circuitry component 50. In the present disclosure, serializer 64 is operable to serialize the data into a serial data that operates and/or runs at approximately 25 megabits per second. Upon such serialization, the serializer 64 is also operable to output the serialized data along an electrical connection to downstream components of the second circuitry component 50. Such operation performed by serializer 64 is noted as step 206 of method 200.

Once step 206 is performed, the serialized data is then received by the IOP 66. At this stage in method 200, IOP 66 is operable to convert the serialized data into a low-voltage differential signal (or LVDS). Upon such conversion, the IOP 66 is also operable to output the LVDS along an electrical connection to downstream components of system 10, specifically the redriver 38 of first circuitry component 30. Such operation performed by IOP 66 is noted as step 208 of method 200.

Once step 206 is performed, the LVDS data is then received by redriver 38 of the first circuitry component 30. At this stage in method 200, redriver is operable to convert LVDS data and/or FPGA output transmitted by the second device 14 to a CML output prior to such signal being received by the first device 12. Such communication between redriver 38 and IOP 66 is performed along two differential wires or electrical connections. Such operation performed by redriver 38 is noted as step 208 of method 200.

Once step 208 is performed, the CML output is then received by second transformer 36 of the first circuitry component 30. At this stage in method 200, second transformer 36 is operable to provide ground isolation to the signal output from communication interface 20 to the first device 12; such operation performed by second transformer is noted as step 210 of method 200. Upon completion of step 210, the first device 12 receives the CML output from second transformer 36 to cease operation of method 200.

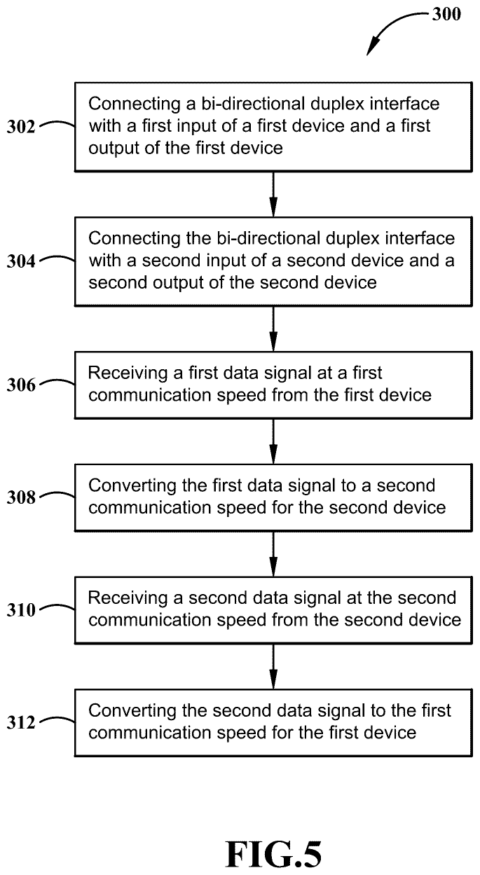

FIG. 5 illustrates another method 300. An initial step 302 of method 300 includes connecting a bi-directional full-duplex interface with a first input of a first device and a first output of the first device. Another step 304 of method 300 includes connecting the bi-directional full-duplex interface with a second input of a second device and a second output of the second device. Another step 306 of method 300 includes receiving a first data signal at a first line code from the first device. Another step 308 of method 300 includes converting the first data signal to a second line code for the second device. Another step 310 of method 300 includes receiving a second data signal at the second line code from the second device. Another step 312 of method 300 includes converting the second data signal to the first line code for the first device.

With respect to method 300, method 300 may include additional and/or optional steps with respect to using the communication interface 20 discussed herein. In one instance, method 300 may include further steps that are mentioned in method 200 regarding the operation of the receive path 22; as such, one or more of steps 202-210 may be included in method 300 if desired. In another instance, method 300 may include further steps that are mentioned in method 300 regarding the operation of the transmit path 24; as such, one or more of steps 302-310 may be included in method 300 if desired.

In another example, a point-to-point communication protocol like MiWi or ZigBee® is used. One or more of the systems of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, programmable logic, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, programmable logic (as in an FPGA, for example), firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the methods or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one. ” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A system, comprising:
a first device operable to communicate at a first line code; wherein the first device is a legacy hardware unit;
a second device operable to communicate at a second line code; and
a bi-directional full-duplex interface connected to the first device and to the second device for communicating between the first device and the second device;
wherein the bi-directional full-duplex interface is transformer coupled and operable to decode or encode a signal between the first device and the second device in the first line code or in the second line code.

2. The system of claim 1, wherein when the bi-directional full-duplex interface receives a first data signal at the first line code from the first device, the bi-directional full-duplex interface is operable to convert the first data signal to the second line code for the second device; and
wherein when the bi-directional full-duplex interface receives a second data signal at the second line code from the second device, the bi-directional full-duplex interface is operable to convert the second data signal to the first line code for the first device.

3. The system of claim 1, wherein the bi-directional full-duplex interface comprises:
a first circuitry component connected with a first input of the first device and a first output of the first device; and
a second circuitry component operable with the first circuitry component and connected with a second input of the second device and a second output of the second device.

4. The system of claim 3, wherein the bi-directional full-duplex interface further comprises:
a receive path that connects the first output of the first device with the second input of the second device, wherein a first data signal is communicated along the receive path; and
a transmit path that connects the second output of the second device with the first input of the first device, wherein a second data signal is communicated along the transmit path.

5. The system of claim 4, wherein the receive path of the first circuitry component comprises:
a receive transformer connected to the first output of the first device; and
an equalizer connected and in series with the receive transformer.

6. The system of claim 5, wherein the receive path of the second circuitry component comprises:
a clock data recovery unit connected and in series with the equalizer;
a reference clock operable with the clock data recovery unit;
a receive framing logic component connected and in series with the clock data recovery unit; and
a decoder connected to the second input of the second device and in series with the receive framing logic component.

7. The system of claim 6, wherein the clock data recovery unit of the second circuitry component comprises:
a transceiver that is operable with the reference clock; and
a clock data recovery block (CDR) connected and in series with the transceiver.

8. The system of claim 4, wherein the transmit path of the second circuitry component comprises:
a transmit framing logic component connected to the second output of the second device;
an encoder connected and in series with the transmit framing logic component;
a serializer connected and in series with the encoder; and
a buffer connected and in series with the serializer.

9. The system of claim 8, wherein the transmit path of the first circuitry component comprises:
a redriver connected and in series with the buffer; and
a transmit transformer connected to the first output of the first device and is in series with the redriver.

10. The system of claim 1, wherein the first line code and the second line code are in different formats.

11. The system of claim 1, wherein the bi-directional full-duplex interface is equipped to the second device and separate from the first device.

12. A bi-directional full-duplex interface that is connected to a first device and to a second device for communicating between the first device and the second device, the bi-directional full-duplex interface comprising:
a first circuitry component connected with a first input of the first device and a first output of the first device; and
a second circuitry component operable with the first circuitry device and connected with a second input of the second device and a second output of the second device;
wherein the bi-directional full-duplex interface is operable to decode or encode a signal between the first device and the second device in the first line code or the second line code.

13. The bi-directional full-duplex interface of claim 12, wherein when the bi-directional full-duplex interface receives a first data signal at a first line code from the first device, the bi-directional full-duplex interface is operable to convert the first data signal to a second line code for the second device; and
wherein when the bi-directional full-duplex interface receives a second data signal at the second line code from the second device, the bi-directional full-duplex interface is operable to convert the second data signal to the first line code for the first device.

14. The bi-directional full-duplex interface of claim 12, wherein the bi-directional full-duplex interface further comprises:
a receive path that connects the first output of the first device with the second input of the second device, wherein a first data signal is communicated along the receive path; and
a transmit path that connects the second output of the second device with the first input of the first device, wherein a second data signal is communicated along the transmit path.

15. The bi-directional full-duplex interface of claim 14, wherein the receive path of the first circuitry component comprises:
a receive transformer connected to the first output of the first device; and
an equalizer connected and in series with the receive transformer.

16. The bi-directional full-duplex interface of claim 15, wherein the receive path of the second circuitry component comprises:
a clock data recovery unit connected and in series with the equalizer;
a reference clock operable with the clock data recovery unit;
a receive framing logic component connected and in series with the clock data recovery unit; and
a decoder connected to the second input of the second device and in series with the receive framing logic component.

17. The bi-directional full-duplex interface of claim 16, wherein the clock data recovery unit of the second circuitry component comprises:
a transceiver that is operable with the reference clock; and
a clock data recovery block (CDR) connected and in series with the transceiver.

18. The bi-directional full-duplex interface of claim 14, wherein the transmit path of the second circuitry component comprises:
a transmit framing logic component connected to the second output of the second device;
an encoder connected and in series with the transmit framing logic component;
a serializer connected and in series with the encoder; and
a buffer connected and in series with the serializer.

19. The bi-directional full-duplex interface of claim 18, wherein the transmit path of the first circuitry component comprises:
a redriver connected and in series with the buffer; and
a transmit transformer connected to the first output of the first device and is in series with the redriver.

20. A method, comprising:
connecting a bi-directional full-duplex interface with a first input of a first device and a first output of the first device;
connecting the bi-directional full-duplex interface with a second input of a second device and a second output of the second device;
receiving a first data signal at a first line code from the first device;
converting the first data signal to a second line code for the second device;
receiving a second data signal at the second line code from the second device; and
converting the second data signal to the first line code for the first device.
